(19) United States
(12) Patent Application Publication
(10) Pub. No.: US 2018/0173740 A1
(43) Pub. Date: Jun. 21, 2018

(54) Apparatus and Method for Sorting Time Series Data

(71) Applicant: General Electric Company, Schenectady, NY (US)

(72) Inventors: Ravi Karra, San Ramon, CA (US); Veera Kishore Reddipalli, San Ramon, CA (US)

(21) Appl. No.: 15/382,207

(22) Filed: Dec. 16, 2016

(51) Int. Cl. G06F 17/30

(52) U.S. Cl. CPC G06F 17/30353; H04L 67/10; G06F 17/30377

(57) ABSTRACT

At the cloud, time series data is received from at least one industrial machine. The time series data is sensed by at least one sensor at the at least one industrial machine and the data arrives out of time-order. The data includes a time indicator of when the data was created. At the cloud, the data is arranged to be in time-order. At the cloud, an analytic is executed using the arranged time series data. In examples, the time order is from the earliest to the latest data.

### BACKGROUND OF THE INVENTION

### Field of the Invention

The subject matter disclosed herein generally relates to analytics, and, more specifically, to managing the organization of data utilized by analytics and potentially other users.

### Brief Description of the Related Art

Various types of industrial machines are used to perform various manufacturing operations and tasks. For instance, some machines are used to create and finish parts associated with wind turbines. Other machines are used to create mechanical parts or components utilized by vehicles. Still other machines are used to produce electrical parts (e.g., resistors, capacitors, and inductors to mention a few examples). Typically, industrial machines are controlled at least in part by computer code (or a computer program) that is executed by a processor that is located at the machine.

The machines often have sensors that measure (or sense) various types of data. For example, temperature, pressure, and speed information may be measured. The sensed information can be used by analytics. Analytics are typically computer programs that operate on the data to provide various results to users. In one example, an analytic may determine the efficiency of a machine or a group of machines. Other analytics can use the data to make predictions of future machine performance.

Large amount of time series data is produced in these systems. However, the data typically arrives out of time order at the analytic. When this occurs, the analytic may not operate properly or provide the best results.

Previous attempts to address these problems have been made, but unfortunately, have not been successful.

### BRIEF DESCRIPTION OF THE INVENTION

The present invention is directed to the improved performance of analytics and other computer programs. Advantageously, time series data that is received out of time-order, is re-organized in time-order, and this increases the operational performance of the analytics. The invention herein may be optionally implemented using a computerized industrial internet of things analytics platform that may be deployed at the location of the manufacturing process, at the manufacturing facility premise or in the cloud (or some other network).

In aspects, time series data arrives at the cloud from various industrial machines (e.g., from sensors on these machines). The data arrives in many cases out of order. The data includes time stamps (or other indicators) of when it was created. At the cloud, the data is arranged to be in order. A time window for the data (e.g., all data from 3:00-3:30 pm is arranged in time-order) may be selected and this time window may be adjusted.

In some of these embodiments, at the cloud, time series data is received from at least one industrial machine. The time series data is sensed by one or more sensors at the industrial machine and the data arrives out of time-order. The data includes a time indicator of when the data was created. At the cloud, the data is arranged to be in time-order. At the cloud, an analytic is executed using the arranged time series data. In examples, the time-order is from the earliest to the latest data.

In some aspects, a time window for the data is selected. In some examples, the time window is adjustable in real-time. In other examples, the time indicator is a time stamp.

In other aspects, the data further includes a tag that identifies a sensor on the machine. In other examples, the sensor comprises a sensor that measures a parameter such as a temperature, a pressure, a speed, an electrical value, or a flow rate. Other examples are possible.

In yet other aspects, the analytic processes the data to perform a function such as determining an efficiency of a machine, determining a problem at the machine, or predicting a future problem at the machine. Other examples are possible.

In others of these embodiments, an apparatus deployed at the cloud includes an interface and a control circuit. The control circuit can be any combination of hardware and/or software elements. The interface is configured to receive time series data from at least one industrial machine. The time series data is sensed by one or more sensors at the industrial machine. The data arrives out of time-order and includes a time indicator of when the data was created.

The control circuit is coupled to the interface. The control circuit is configured to arrange the data to be in time-order and transmit the arranged time series data to a processor via the interface. The processor is deployed at the cloud. The processor is configured to execute an analytic using the arranged time series data.

### BRIEF DESCRIPTION OF THE DRAWINGS

For a more complete understanding of the disclosure, reference should be made to the following detailed description and accompanying drawings wherein:

FIG. 1 comprises a block diagram of a system for organizing time series data according to various embodiments of the present invention;

FIG. 2 comprises a block diagram of an apparatus that organizes time series data according to various embodiments of the present invention;

FIG. 3 comprises a flow chart of an approach for organizing time series data according to various embodiments of the present invention;

FIG. 4 comprises a block diagram showing some steps of organizing time series data according to various embodiments of the present invention;

FIG. 5 comprises a block diagram that shows a system for organizing time series data according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The present approaches advantageously arrange time series data in time-order. The time series data arrives out of time-order, and by re-arranging the data in time-order, the analytics can operate more quickly, efficiently, and accurately. Thus, the analytics provide more accurate results, more quickly to their users.

In an internet of things (IoT) landscape, components typically include sensors and edge devices. These devices continuously emit time series data. In aspects, each time series data point (or record) includes a timestamp, a tag identifier, and value. Massive number of time series data points are produced by devices and sensors, and this massive amount of data flows into the cloud. The present approaches establish time series data streaming with order guaranteed within each micro batch with or without a slide window. In some aspects, ordering is a lazy operation, which does not impact the throughput of edge to the cloud.

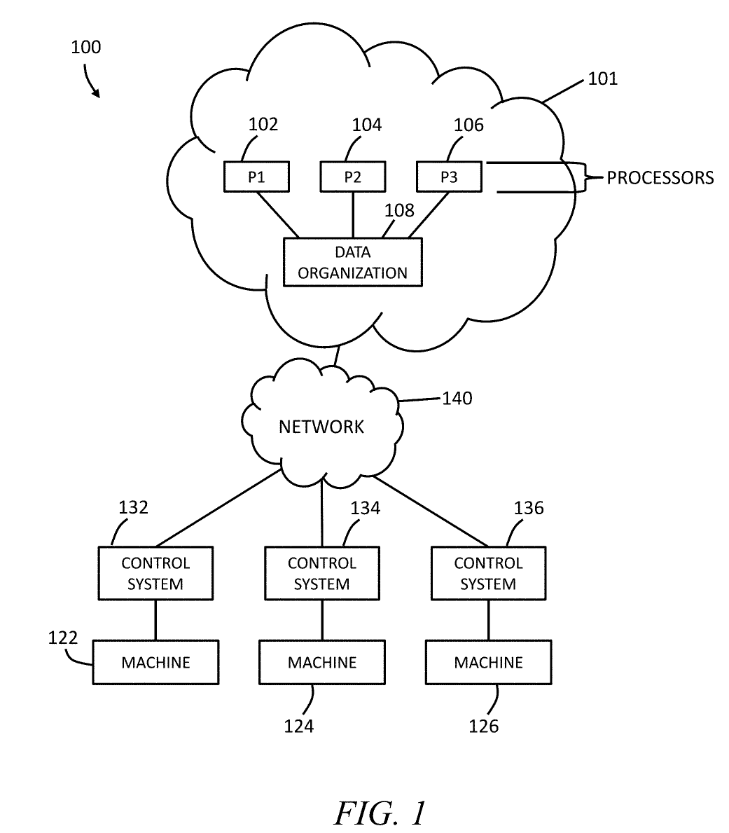

Referring now to FIG. 1, one example of a system 100 for organizing time series data is described. The cloud 101 includes data processors 102, 104, and 106. A data organization apparatus 108 is coupled to the processors 102, 104, and 106.

Industrial machines 122, 124, and 126 couple to control systems 132, 134, and 136. The control system 132, 134, and 136, couple to a network 140, which couples to the cloud 101. Time series data collected by the machines 122, 124, and 126 flows through the control systems 132, 134, and 136, through the network 140, to the cloud 101 (and the data organization apparatus 108 in the cloud 101).

The data processors 102, 104, and 106 are any type of data processing apparatus or system. The data processors may execute analytics. In examples, the analytics perform operations on time series data. For example, analytics may determine the efficiency of machines (which source the time series data). The analytics may also make predictions about future machine operation or performance. Based upon results of the analytics, corrective action (e.g., sending alerts to users) can be taken.

The data organization apparatus 108 may be implemented as any combination of hardware and software. For example, the data organization apparatus 108 may be implemented as a processor or control circuit executing computer instructions stored in a memory.

Industrial machines 122, 124, and 126 are any type of industrial machine. In example, the machine may be any type of machine deployed in factories, offices, schools, or other organizational units (such as wind farms). For instance, some machines are used to create and finish parts associated with wind turbines. Other machines are used to create mechanical parts or components utilized by vehicles. Still, other machines are used to produce electrical parts (e.g., resistors, capacitors, and inductors to mention a few examples). Windmills are another example of a machine.

Control systems 132, 134, and 136 control the operation of the industrial machines 122, 124, and 126. In aspects, the control systems 132, 134, and 136 may include programmable logic controllers (PLCs) that are programmed to control the operation of the machines 122, 124, and 126. The control systems 132, 134, and 136 also act as a conduit for time series data collected by the machines 122, 124, and 126 through the network 140, to the cloud 101.

The network 140 and the cloud 101 are networks that include gateways, routers, and other network devices.

In one example of the operation of the system of FIG. 1, at the cloud 101, time series data is received from at least one of the industrial machines 122, 124, and 126. The time series data is sensed by sensors at the machines 122, 124, and 126. The data arrives out of time-order. That is, data that was sensed (or created) earlier in time arrives later than data that was sensed (or created) later in time. The data includes a time indicator of when the data was created. At the cloud 101, the data is arranged to be in time-order by the data organization apparatus 108. At the cloud 101, an analytic is executed at one of the processors 102, 104, and/or 106 using the properly arranged time series data received from the data organization apparatus 108. In examples, the time order is from the earliest data (in-time) to the latest data (in-time).

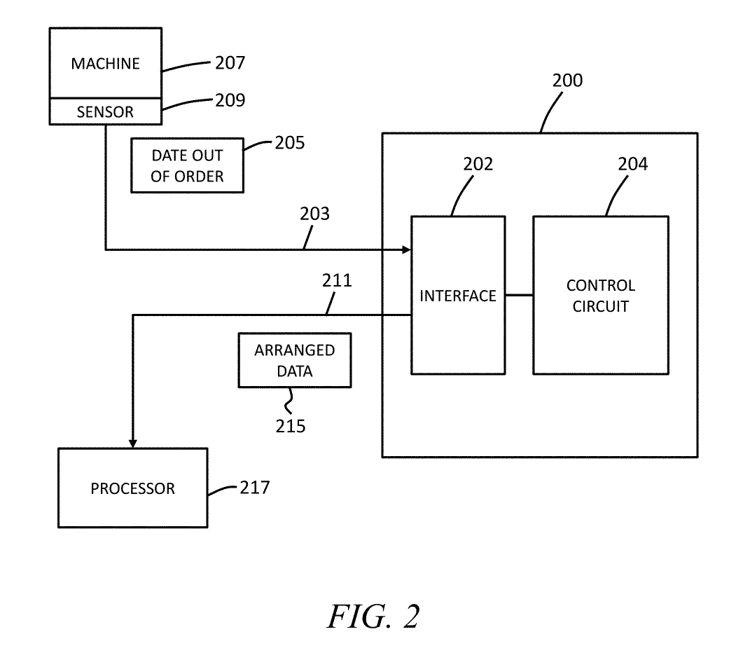

Referring now to FIG. 2, one example of an apparatus 200 for organizing time series data is described. The apparatus 200 is deployed at the cloud and includes an interface 202 and a control circuit 204. The interface 202 has an input 203 that is configured to receive time series data 205 from at least one industrial machine 207. The time series data 205 is sensed by at least one sensor 209 at the at least one industrial machine 207. The data 205 arrives out of time-order and includes a time indicator of when the data was created.

The control circuit 204 is coupled to the interface 202. The control circuit can be implemented as any combinations of computer hardware and/or software, and may include a memory. The control circuit 204 is configured to arrange the data 205 to be in time-order and transmit the arranged time series data 215 to a processor 217 via an output 211 interface. The processor 217 is deployed at the cloud. The processor 217 is configured to execute an analytic using the arranged time series data.

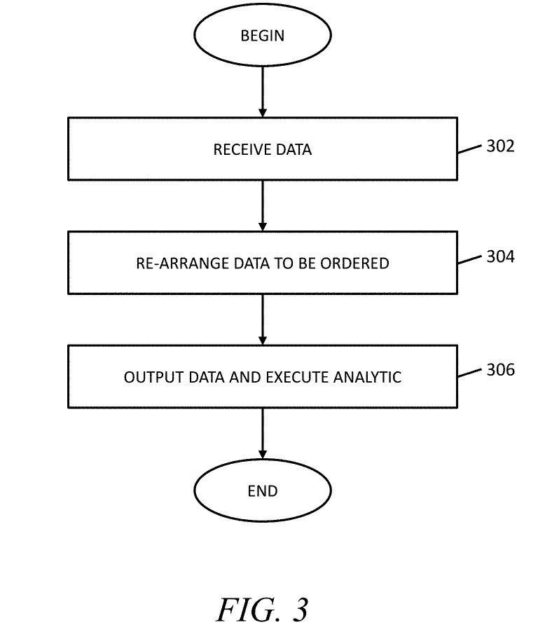

Referring now to FIG. 3, one example an approach for organizing time series data is described. At step 302, at the cloud, time series data is received from at least one industrial machine. The time series data is sensed by at least one sensor at the at least one industrial machine and the data arrives out of time-order. The data includes a time indicator of when the data was created. In other examples, the time indicator is a time stamp.

In some aspects, a time window for the data is selected. In some examples, the time window is adjustable in real-time. For example, the time window may be a week or a day. Other examples of time windows are possible. In still other examples, the time window can be driven or selected by events (e.g., a start or end event). In other aspects, the window can be dynamically re-adjusted based upon the events received for calculations in real-time.

At step 304 and at the cloud, the data is arranged to be in time-order. The arrangement may be according to any type of sorting algorithm or approach. The time series data may be in the form of records, and the records can be arranged from earliest to latest. However, other orderings are possible. At step 306 and at the cloud, the data is output and an analytic is executed using the arranged time series data. The analytic processes the data to perform a function such as determining an efficiency of the machine, determining a problem at the machine, and predicting a future problem at the machine. Other examples are possible.

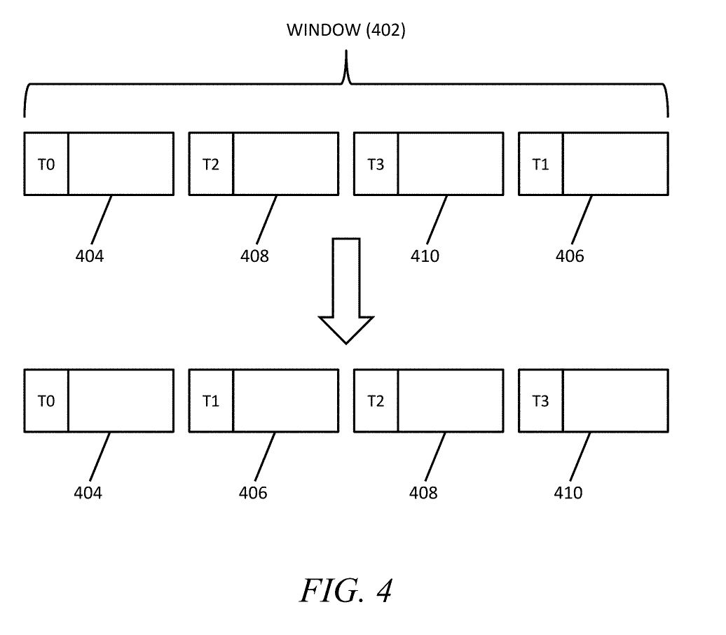

Referring now to FIG. 4, one example showing the arrangement of time series data, according to the present approaches is described. A time window 402 includes four data records 404, 406, 408, and 410 with time stamps T0, T1, T2, and T3. Time T0 is the first time in time-order, time T1, is the second time in time-order, time T2 is the next time in time-order, and time T3 is the next time in time-order. For example, T0 may be 10:00, T1 may be 10:01, T2 may be 10:02, and T3 may be 10:03.

Initially, the records are received out of time-order. That is initially, the records are received in the order 404 (T0), 408 (T2), 410 (T3), and 406 (T1). However, after following the present approaches, the records are ordered as 404 (T0), 406 (T1), 408 (T2), and 410 (T3). The records may be stored in any memory device such as a buffer. The sorting may be performed on the records as they are stored in the buffer according to any number of sorting approaches or algorithms. The records may be sorted from earliest in time to latest in time, or may be sorted from latest in time to earliest in time. In still other aspects, the records may be sorted by some other criteria (e.g., the value of the record).

The records may also include tag names which identify the sensors that supplied the data. For example, a tag name may be “XO” or “sensor1”. Additionally, the records can have a field with the sensed value of the identified sensor at the identified time.

As mentioned, the approaches described herein may optionally be implemented using a computerized industrial interne of things analytics platform that may be deployed at the location of the manufacturing process, at the manufacturing facility premise, or in the cloud.

While progress with industrial equipment automation has been made over the last several decades, and assets have become “smarter,” the intelligence of any individual asset pales in comparison to intelligence that can be gained when multiple smart devices are connected together. Aggregating data collected from or about multiple assets can enable users to improve business processes, for example by improving effectiveness of asset maintenance or improving operational performance if appropriate industrial-specific data collection and modeling technology is developed and applied.

In an example, an industrial asset can be outfitted with one or more sensors configured to monitor respective ones of an asset's operations or conditions. Data from the one or more sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, or to enhance software algorithms for operating the same or similar asset at its edge, that is, at the extremes of its expected or available operating conditions.

The systems and methods for managing industrial machines (also referred to assets herein) can include or can be a portion of an Industrial Internet of Things (IIoT). In an example, an IIoT connects industrial assets, such as turbines, jet engines, and locomotives, to the Internet or cloud, or to each other in some meaningful way. The systems and methods described herein can include using a “cloud” or remote or distributed computing resource or service. The cloud can be used to receive, relay, transmit, store, analyze, or otherwise process information for or about one or more industrial assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

However, the integration of industrial assets with the remote computing resources to enable the IIoT often presents technical challenges separate and distinct from the specific industry and from computer networks, generally. A given industrial asset may need to be configured with novel interfaces and communication protocols to send and receive data to and from distributed computing resources. Given industrial assets may have strict requirements for cost, weight, security, performance, signal interference, and the like such that enabling such an interface is rarely as simple as combining the industrial asset with a general purpose computing device.

To address these problems and other problems resulting from the intersection of certain industrial fields and the IIoT, embodiments may enable improved interfaces, techniques, protocols, and algorithms for facilitating communication with and configuration of industrial assets via remote computing platforms and frameworks. Improvements in this regard may relate to both improvements that address particular challenges related to particular industrial assets (e.g., improved aircraft engines, wind turbines, locomotives, medical imaging equipment) that address particular problems related to use of these industrial assets with these remote computing platforms and frameworks, and also improvements that address challenges related to operation of the platform itself to provide improved mechanisms for configuration, analytics, and remote management of industrial assets.

The Predix™ platform available from GE is a novel embodiment of such Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

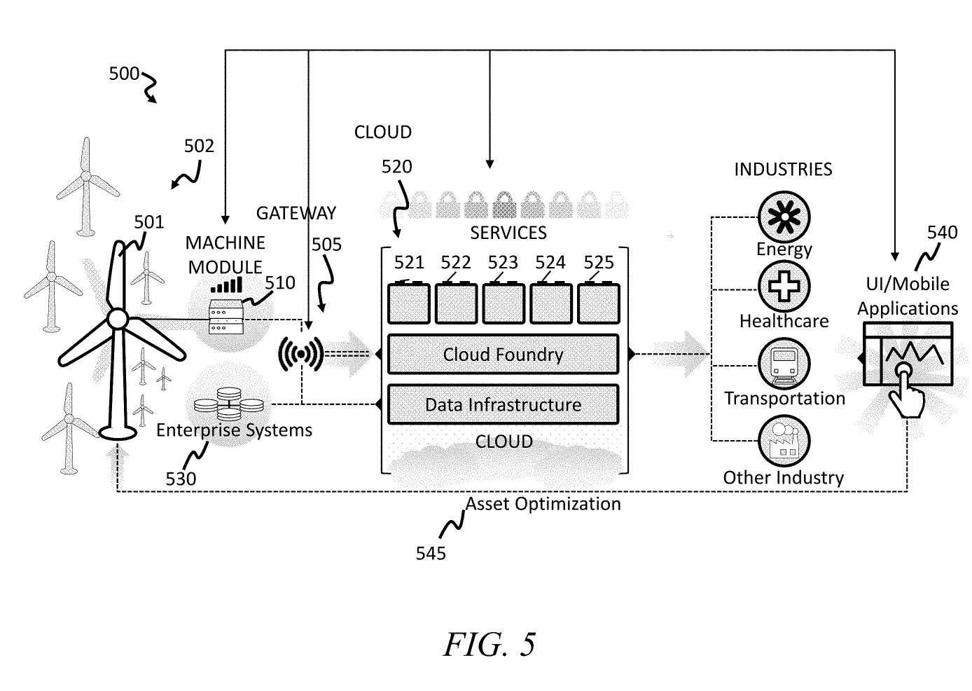

FIG. 5 illustrates generally an example of portions of a first AMP 500. As further described herein, one or more portions of an AMP can reside in an asset cloud computing system 520, in a local or sandboxed environment, or can be distributed across multiple locations or devices. An AMP can be configured to perform any one or more of data acquisition, data analysis, or data exchange with local or remote assets, or with other task-specific processing devices.

The first AMP 500 includes a first asset community 502 that is communicatively coupled with the asset cloud computing system 520. In an example, a machine module 510 receives information from, or senses information about, at least one asset member of the first asset community 502, and configures the received information for exchange with the asset cloud computing system 520. In an example, the machine module 510 is coupled to the asset cloud computing system 520 or to an enterprise computing system 530 via a communication gateway 505.

In an example, the communication gateway 505 includes or uses a wired or wireless communication channel that extends at least from the machine module 510 to the asset cloud computing system 520. The asset cloud computing system 520 includes several layers. In an example, the asset cloud computing system 520 includes at least a data infrastructure layer, a cloud foundry layer, and modules for providing various functions. In the example of FIG. 5, the asset cloud computing system 520 includes an asset module 521, an analytics module 522, a data acquisition module 523, a data security module 524, and an operations module 525. Each of the modules 521-525 includes or uses a dedicated circuit, or instructions for operating a general purpose processor circuit, to perform the respective functions. In an example, the modules 521-525 are communicatively coupled in the asset cloud computing system 520 such that information from one module can be shared with another. In an example, the modules 521-525 are co-located at a designated datacenter or other facility, or the modules 521-525 can be distributed across multiple different locations.

An interface device 540 can be configured for data communication with one or more of the machine module 510, the gateway 505, or the asset cloud computing system 520. The interface device 540 can be used to monitor or control one or more assets. In an example, information about the first asset community 502 is presented to an operator at the interface device 540. The information about the first asset community 502 can include information from the machine module 510, or the information can include information from the asset cloud computing system 520. In an example, the information from the asset cloud computing system 520 includes information about the first asset community 502 in the context of multiple other similar or dissimilar assets, and the interface device 540 can include options for optimizing one or more members of the first asset community 502 based on analytics performed at the asset cloud computing system 520.

In an example, an operator selects a parameter update for the first wind turbine 501 using the interface device 540, and the parameter update is pushed to the first wind turbine via one or more of the asset cloud computing system 520, the gateway 505, and the machine module 510. In an example, the interface device 540 is in data communication with the enterprise computing system 530 and the interface device 540 provides an operation with enterprise-wide data about the first asset community 502 in the context of other business or process data. For example, choices with respect to asset optimization can be presented to an operator in the context of available or forecasted raw material supplies or fuel costs. In an example, choices with respect to asset optimization can be presented to an operator in the context of a process flow to identify how efficiency gains or losses at one asset can impact other assets. In an example, one or more choices described herein as being presented to a user or operator can alternatively be made automatically by a processor circuit according to earlier-specified or programmed operational parameters. In an example, the processor circuit can be located at one or more of the interface device 540, the asset cloud computing system 520, the enterprise computing system 530, or elsewhere.

Returning again to the example of FIG. 5, some capabilities of the first AMP 500 are illustrated. The example of FIG. 5 includes the first asset community 502 with multiple wind turbine assets, including the first wind turbine 501. Wind turbines are used in some examples herein as non-limiting examples of a type of industrial asset that can be a part of, or in data communication with, the first AMP 500.

In an example, the multiple turbine members of the asset community 502 include assets from different manufacturers or vintages. The multiple turbine members of the asset community 502 can belong to one or more different asset communities, and the asset communities can be located locally or remotely from one another. For example, the members of the asset community 502 can be co-located on a single wind farm, or the members can be geographically distributed across multiple different farms. In an example, the multiple turbine members of the asset community 502 can be in use (or non-use) under similar or dissimilar environmental conditions, or can have one or more other common or distinguishing characteristics.

FIG. 5 further includes the device gateway 505 configured to couple the first asset community 502 to the asset cloud computing system 520. The device gateway 505 can further couple the asset cloud computing system 520 to one or more other assets or asset communities, to the enterprise computing system 530, or to one or more other devices. The first AMP 500 thus represents a scalable industrial solution that extends from a physical or virtual asset (e.g., the first wind turbine 501) to a remote asset cloud computing system 520. The asset cloud computing system 520 optionally includes a local system, enterprise, or global computing infrastructure that can be optimized for industrial data workloads, secure data communication, and compliance with regulatory requirements.

In an example, information from an asset, about the asset, or sensed by an asset itself is communicated from the asset to the data acquisition module 524 in the asset cloud computing system 520. In an example, an external sensor can be used to sense information about a function of an asset, or to sense information about an environment condition at or near an asset. The external sensor can be configured for data communication with the device gateway 505 and the data acquisition module 524, and the asset cloud computing system 520 can be configured to use the sensor information in its analysis of one or more assets, such as using the analytics module 522.

In an example, the first AMP 500 can use the asset cloud computing system 520 to retrieve an operational model for the first wind turbine 501, such as using the asset module 521. The model can be stored locally in the asset cloud computing system 520, or the model can be stored at the enterprise computing system 530, or the model can be stored elsewhere. The asset cloud computing system 520 can use the analytics module 522 to apply information received about the first wind turbine 501 or its operating conditions (e.g., received via the device gateway 505) to or with the retrieved operational model. Using a result from the analytics module 522, the operational model can optionally be updated, such as for subsequent use in optimizing the first wind turbine 501 or one or more other assets, such as one or more assets in the same or different asset community. For example, information about the first wind turbine 501 can be analyzed at the asset cloud computing system 520 to inform selection of an operating parameter for a remotely located second wind turbine that belongs to a different second asset community.

The first AMP 500 includes a machine module 510. The machine module 510 includes a software layer configured for communication with one or more industrial assets and the asset cloud computing system 520. In an example, the machine module 510 can be configured to run an application locally at an asset, such as at the first wind turbine 501. The machine module 510 can be configured for use with or installed on gateways, industrial controllers, sensors, and other components. In an example, the machine module 510 includes a hardware circuit with a processor that is configured to execute software instructions to receive information about an asset, optionally process or apply the received information, and then selectively transmit the same or different information to the asset cloud computing system 520.

In an example, the asset cloud computing system 520 can include the operations module 525. The operations module 525 can include services that developers can use to build or test Industrial Internet applications, or the operations module 525 can include services to implement Industrial Internet applications, such as in coordination with one or more other AMP modules. In an example, the operations module 525 includes a microservices marketplace where developers can publish their services and/or retrieve services from third parties. The operations module 525 can include a development framework for communicating with various available services or modules. The development framework can offer developers a consistent look and feel and a contextual user experience in web or mobile applications.

In an example, an AMP can further include a connectivity module. The connectivity module can optionally be used where a direct connection to the cloud is unavailable. For example, a connectivity module can be used to enable data communication between one or more assets and the cloud using a virtual network of wired (e.g., fixed-line electrical, optical, or other) or wireless (e.g., cellular, satellite, or other) communication channels. In an example, a connectivity module forms at least a portion of the gateway 505 between the machine module 510 and the asset cloud computing system 520.

In an example, an AMP can be configured to aid in optimizing operations or preparing or executing predictive maintenance for industrial assets. An AMP can leverage multiple platform components to predict problem conditions and conduct preventative maintenance, thereby reducing unplanned downtimes. In an example, the machine module 510 is configured to receive or monitor data collected from one or more asset sensors and, using physics-based analytics (e.g., finite element analysis or some other technique selected in accordance with the asset being analyzed), detect error conditions based on a model of the corresponding asset. In an example, a processor circuit applies analytics or algorithms at the machine module 510 or at the asset cloud computing system 520.

In response to the detected error conditions, the AMP can issue various mitigating commands to the asset, such as via the machine module 510, for manual or automatic implementation at the asset. In an example, the AMP can provide a shut-down command to the asset in response to a detected error condition. Shutting down an asset before an error condition becomes fatal can help to mitigate potential losses or to reduce damage to the asset or its surroundings. In addition to such an edge-level application, the machine module 510 can communicate asset information to the asset cloud computing system 520.

In an example, the asset cloud computing system 520 can store or retrieve operational data for multiple similar assets. Over time, data scientists or machine learning can identify patterns and, based on the patterns, can create improved physics-based analytical models for identifying or mitigating issues at a particular asset or asset type. The improved analytics can be pushed back to all or a subset of the assets, such as via multiple respective machine modules 510, to effectively and efficiently improve performance of designated (e.g., similarly-situated) assets.

In an example, the asset cloud computing system 520 includes a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA mappings to underlying infrastructure. This configuration can be useful when an application requires an underlying hardware configuration. The provisioning management and pooling of resources can be done at a granular level, thus allowing optimal resource allocation.

In a further example, the asset cloud computing system 520 is based on Cloud Foundry (CF), an open source PaaS that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The asset cloud computing system 520 can include a data services module that can facilitate application development. For example, the data services module can enable developers to bring data into the asset cloud computing system 520 and to make such data available for various applications, such as applications that execute at the cloud, at a machine module, or at an asset or other location. In an example, the data services module can be configured to cleanse, merge, or map data before ultimately storing it in an appropriate data store, for example, at the asset cloud computing system 520. A special emphasis has been placed on time series data, as it is the data format that most sensors use.

Security can be a concern for data services that deal in data exchange between the asset cloud computing system 520 and one or more assets or other components. Some options for securing data transmissions include using Virtual Private Networks (VPN) or an SSL/TLS model. In an example, the first AMP 500 can support two-way TLS, such as between a machine module and the security module 524. In an example, two-way TLS may not be supported, and the security module 524 can treat client devices as OAuth users. For example, the security module 524 can allow enrollment of an asset (or other device) as an OAuth client and transparently use OAuth access tokens to send data to protected endpoints.

In the example of FIG. 5, it will be understood that the approaches described herein with respect to FIGS. 1-4 may be implemented using the AMP 500 that may be deployed at the first asset community 502, at the wind turbine 501, or in the cloud 520. In one example, the apparatus 200 of FIG. 2 may be deployed at any of these locations.

It will be appreciated by those skilled in the art that modifications to the foregoing embodiments may be made in various aspects. Other variations clearly would also work, and are within the scope and spirit of the invention. It is deemed that the spirit and scope of that invention encompasses such modifications and alterations to the embodiments herein as would be apparent to one of ordinary skill in the art and familiar with the teachings of the present application.

What is claimed is:

1. A method, comprising:
at the cloud, receiving time series data from at least one industrial machine, the time series data being sensed by at least one sensor at the at least one industrial machine, the data arriving out of time-order, the data including a time indicator of when the data was created;
at the cloud, arranging the data to be in time-order;
at the cloud, executing an analytic using the arranged time series data.

2. The method of claim 1, further comprising selecting a time window for the data.

3. The method of claim 2, wherein the time window is adjustable in real-time.

4. The method of claim 1, wherein the time indicator is a time stamp.

5. The method of claim 1, wherein the data further includes a tag that identifies a sensor on the machine.

6. The method of claim 1, wherein the at least one sensor comprises a sensor that measures a parameter selected from the group consisting of: a temperature, a pressure, a speed, an electrical value, and a flow rate.

7. The method of claim 1, wherein the analytic processes the data to perform a function, the function selected from the group consisting of: determining an efficiency of the at least one machine, determining a problem at the at least one machine, and predicting a future problem at the at least one machine.

8. The method of claim 1, wherein the time-order is from the earliest to the latest data.

9. An apparatus deployed at the cloud, the apparatus comprising:
an interface, the interface configured to receive time series data from at least one industrial machine, the time series data being sensed by at least one sensor at the at least one industrial machine, the data arriving out of time-order, the data including a time indicator of when the data was created;
a control circuit coupled to the interface, the control circuit configured to arrange the data to be in time-order and transmit the arranged time series data to a processor via the interface, the processor deployed at the cloud, the processor configured to execute an analytic using the arranged time series data.

10. The apparatus of claim 9, further comprising selecting a time window for the data.

11. The apparatus of claim 10, wherein the time window is adjustable in real-time.

12. The apparatus of claim 9, wherein the time indicator is a time stamp.

13. The apparatus of claim 9, wherein the data further includes a tag that identifies a sensor on the machine.

14. The apparatus of claim 9, wherein the at least one sensor comprises a sensor that measures a parameter selected from the group consisting of: a temperature, a pressure, a speed, an electrical value, and a flow rate.

15. The apparatus of claim 9, wherein the analytic processes the data to perform a function, the function selected from the group consisting of: determining an efficiency of the at least one machine, determining a problem at the at least one machine, and predicting a future problem at the at least one machine.

16. The apparatus of claim 9, wherein the time-order is from the earliest to the latest data.
